(19) United States
(12) Patent Application Publication
(10) Pub. No.: US 2005/0008148 A1
(43) Pub. Date: Jan. 13, 2005

(54) Mouse performance identification

(76) Inventor: Dov Jacobson, Berkeley Lake, GA (US)

Correspondence Address: DOV JACOBSON, 620 Lakeshore Drive, Berkeley Lake, GA, 30096-3038, US

(21) Appl. No.: 10/816,123

(22) Filed: Apr. 1, 2004

Related U.S. Application Data
(60) Provisional application No. 60/459,858, filed on Apr. 2, 2003.

(51) Int. Cl. H04L 9/00; G06F 17/60

(52) U.S. Cl. 380/26; 380/232; 713/168; 713/200; 705/44

(57) ABSTRACT

Methods and system for facilitating authentication of users of a mouse device. Different individuals have different ways of manipulating a mouse to enter mouse-clicks requested via an on-screen image or other software programs. An individual's characteristic way of manipulating the mouse is determined and stored and later retrieved to facilitate verification of a user's identification.

### CROSS REFERENCE TO RELATED PATENTS

This application claims the benefit of Provisional Patent Application Serial Number:

### FEDERALLY SPONSORED RESEARCH AND DEVELOPMENT

This invention was supported in part by the National Science Foundation, DMI-0232772.

The Government has certain rights in this invention.

### FIELD OF INVENTION

The invention relates to methods and systems for authenticating individuals, and more particularly to authenticating individuals based on an individual's characteristic way of manipulating a mouse device.

### BACKGROUND

In today's computer environment, inputs required by hardware devices and application programs are often entered using a mouse device (hereinafter “mouse”). Briefly, a user manipulates a mouse to move the corresponding cursor to a desired location on the computer screen and enters inputs requested by on-screen prompts or a graphic user interfaces (hereinafter “GUI”). The user responds by clicking an appropriate mouse button, that is, typically, the left or right mouse button.

Furthermore, in today's distributed network environment, the identification or authentication of a user represents a critical component in determining the success and reliability of such technology. Access by an unauthorized user can result in a heavy monetary loss and erode consumers' confidence in such a network, thereby limiting the growth of on-line or Internet transactions.

Accordingly, there are numerous techniques and devices being built to authenticate a user trying to access a particular network or a web page. Prior methods include devices for detection traditional biometrics such as the voice or fingerprints of individuals, and typically require input devices that are not yet readily available to ordinary users.

The present invention provides new methods and systems for facilitating authentication of an individual user based on the user's characteristic way of manipulating the mouse.

Automated online authentication is a problem that dates back to the origins of remote computing. Password security has well-established weaknesses and system administrators have long sought methods that combine security, comfort and low cost. This quest has become more important as online transactions become more ubiquitous throughout our economy and our culture, more significant in the value of decisions authorized and more frequent in the course of an ordinary day.

Biometrics applies direct measurement of unique personal features to the authentication problem. Physical biometrics measure physiological attributes: such as iris patterns or fingerprint minutia. Behavioral biometrics measure human activity, such as speech or a signature. Biometrics offers very secure authentication, but the testing procedure is often inconvenient, uncomfortable or undignified. Furthermore, the requisite hardware is frequently expensive. Much research is dedicated to removing these shortcomings.

In 1971, electronic signature recognition systems are first introduced. These inventions predate the existence of a reliable two-dimensional pointing device such as a mouse or a graphics tablet. They rely entirely on a one-dimensional pattern of pressure changes. U.S. Pat. Nos. 3,579,186 and 3,618,019 teach such systems, based respectively on a pressure-sensitive pen and a pressure-sensitive signing surface.

The results of this automated signature recognition are quickly improved. U.S. Pat. No. 3,699,517 introduces the measurement of lateral acceleration as the pen is driven across the signing surface. Herbst teaches, in extraordinary detail, in U.S. Pat. No. 3,983,535 (and later in U.S. Pat. No. 4,128,829), methods for signature recognition using planar coordinates, as well as force measurements, as the x,y tracking tablet makes its dramatic appearance..

Further improvements to the signing instruments are taught in U.S. Pat. Nos. 4,308,522, 4,513,437 and 4,646,351. Advances in analytic technique beyond Herbst's segmentization and correlation analysis are taught in U.S. Pat. No. 4,736,445 (spectrum analysis), and U.S. Pat. No. 5,202,930 (phase shift analysis).

U.S. Pat. No. 5,040,222 teaches a pattern generation method of analysis which, while developed originally to recognize hand-formed Kanji characters, also has value in signature identification.

All this art, while increasingly sophisticated, is limited in application by its hardware requirements, namely the specialized signing instrument. Such scriber hardware has worth in dedicated systems such as a point-of-sale authentication device or at the gateway to a secure facility. However it will not solve the authentication needs of the vast majority of computers which are equipped with only keyboard and mouse.

To address this problem, the 1986 U.S. Pat. No. 4,621,334 teaches a method of user identification based solely on the keystroke timing. The individuality of key rhythms had been noted since the early days of telegraphy, when professional telegraph operators reported that they could readily recognize the ‘fist’ of other operators. (UNESCO Courier August 1999)

Interest in the field of keystroke dynamics is immediate, as administrators respond to the value of a system that offers biometric identification without requiring special hardware. However the ordinary computer keyboard is not a good instrument for precision measurements of rhythm. Standard computer keyboard scan rates are relatively slow (30msec) and accuracy can only be increased by averaging large samples. The National Science Foundation commissions a RAND corporation study (R 2526-NSF, 1980) to determine the value of keystroke dynamics. The report states that reliable results could not be obtained unless the system examines a typing sample of at least a full page of text.

This lengthy test, combined with a parallel requirement for very long training sessions, has confined the utility of keystroke dynamics to solving special security problems, such as continual and surreptitious identity test for data entry clerks. Such applications were uncommon in the 1980's and have become only more rare in our time as mouse actions predominate over keyboard commands and bulk data entry is often automated.

To reach a broader market, many attempts are made to improve the Rand results. Novel statistical analysis is one path to improvement. Garcia, in U.S. Pat. No. 4,621,334 applies Mahalnobis distance discrimination to the problem. Garcia's aim—recognition of users based on a few typed characters, using a hardware platform whose resolution is a crude 500 milliseconds—suggests an optimism uncurbed by experimentation.

Researchers continue to approach the problem of keystroke dynamics with new computational tools are as each becomes popular. For example, U.S. Pat. No. 5,557,686 (1996) teaches the application of neural net technology.

Nevertheless, irreducible principles of pattern classification suggest a limit beyond which ingenious mathematics cannot compensate for imprecise and skimpy data. Abundant, accurate data is particularly important when measuring the vagaries of an informal human behavior such as untrained typing.

More substantial improvements to keystroke dynamics can be achieved by employing specialized keyboards. Such mechanisms can provide finer time resolution or can measure key pressure, as taught in U.S. Pat. No. 4,805,222. In achieving this improvement, however, such systems abandon the prized advantage of using standardized hardware.

U.S. Pat. No. 6,062,474 (2000) teaches a novel application: specifically to the keypad of an automated teller machine (ATM). While the taught system, in a specially built ATM can incorporate high precision timing circuitry, this method is still plagued by the very small data sample. A four digit PIN offers only seven data points.

This undersampling problem is interestingly addressed by U.S. Pat. No. 5,721,765 (1998) which teaches a PIN in which timing is used to strengthen the normal four digit PIN. In this system, the user chooses a PIN which may or may not have voluntary pauses between some digits. While interesting, the system is not a biometric technique, but an extension of password/PIN technology and one which adds only three more information bits to a system that currently exceeds thirteen bits of security.

As the mouse replaces the keyboard as the principle instrument for user input, efforts are made to integrate the mouse into biometric process. The majority of these efforts have recognized the intimate, persistent and precisely located contact between the mouse button and the operator's forefinger. Using this knowledge, inventors have placed a variety of sensor devices on the button in order to record fingerprint minutia. Such a system is taught in U.S. Pat. Nos. 5,838,306 and 6,337.919. Research is also reported on a mouse that can sense the vascular patterns of the user's palm.

Recent U.S. Pat. No. 6,572,014 teaches a system of surreptitious “in-session” identity monitoring using a biometric mouse. In this system, the mouse might have voiceprint, face, fingerprint, palm print or chemometric sensors. Interestingly, no behavioral biometric is contemplated in this imaginative litany.

Currently (BBC News Sep. 3, 2003) McOwan of Queen Mary University in London is announcing a system for signing documents with a mouse. This behavioral mouse biometric measures the attempt of the claimant to literally scribe a signature using the mouse. While reporting some success in identification, McOwan demands of his users an unfamiliar and difficult task. Scribing with a mouse has been likened to drawing with a bar of soap. Besides its clumsy shape, the mouse is a relative positioning device ill-suited for signature. Users are uncomfortable with the task and displeased with the results—by contrast most people have pride in their pen-drawn signatures. In addition to user resistance, McOwan must contend with user learning. Familiarity leads to improved performance and any change in performance introduces errors in identification.

It should be noted that all prior art which involves a pointing device (mouse or stylus), performs data recording only during the ‘pen-down’ (drawing) phase. This is a historical holdover from signature analysis. The current invention mines the rich data stream during the pen-up period, in addition to the familiar pen-down trace.

Thanks to this feature and others, the present invention can resolve the three serious shortcomings obvious in the prior art:

Hardware dependency: Unlike fingerprint-sensing mice or signature pens, this invention uses perfectly standard hardware. Six million mice are manufactured every month, and this system can be used with all of them.

Data Paucity: Keystroke dynamics also requires only standard hardware and also demands only common behaviors. But it delivers only two data values for each click, and these are of crude accuracy (30 msec). By contrast, in the current invention a single click yields approximately 100 high resolution (8 msec) data points in each of three dimensions.

### SUMMARY

The present invention facilitates authentication of individual users of a mouse by detecting mouse micromotions characteristic of each individual user. A composite of a plurality of metrics characterizing a user's particular way of manipulating a mouse is captured and processed. The composite is then compared with the information in a database comprising micromotions of authorized users to determine the likelihood that the particular user is an authorized user. As an example, a user enters mouse-clicks representing a short identification sequence such as a credit card number via a GUI, comprising target areas. Briefly, the user uses an ordinary mouse to enter a mouse-click by clicking an appropriate mouse button after placing the cursor corresponding to the mouse within a target area.

According to the present invention, software components embodying the principles of the present invention facilitate authentication of a user based solely on the user's personal way of moving and/or manipulating (hereinafter “manipulating”) the mouse to enter mouse-clicks. In particular, even if a user enters a correct identification sequence, if his way of manipulating the mouse is different from the authorized user, the requested access can be denied.

### BRIEF DESCRIPTION OF THE DRAWINGS

FIG. 1 illustrates the trace that a mouse device makes as the cursor corresponding to the movement of the mouse is displaced from a first point to a second point.

FIG. 2 illustrates the accuracy metric according to the present invention.

FIG. 3 illustrates the bias metric according to the present invention.

FIG. 4 illustrates the click duration metric according to the present invention.

FIG. 5 illustrates the confirmation dependency metric according to the present invention.

FIG. 6 illustrates the convexity metric according to the present invention.

FIG. 7 illustrates the double-click rhythm metric according to the present invention.

FIG. 8 illustrates the mouse-down travel and inter-click drag metric according to the present invention.

FIG. 9 illustrates the over-click metric according to the present invention.

FIG. 10 illustrates the overshoot and braking metric according to the present invention.

FIG. 11a illustrates the speed and acceleration metric according to the present invention.

FIG. 11b illustrates the velocity of the mouse device, where for a given circle or ellipse, the length in the y direction and the length in the x direction are proportional to the velocities of the mouse in the x and y directions, respectively, at the point corresponding to the circle or ellipse.

FIG. 12a illustrates the tremor and wobble metric according to the present invention.

FIGS. 12b, 12c and 12d illustrates the correction metric according to the present invention.

FIG. 13 illustrates an exemplary image screen used to determine an individual's characteristic way of manipulating the mouse.

FIG. 14 illustrates an exemplary computer network in which an embodiment according to the present invention is used to facilitate authentication of the user of the mouse.

FIG. 15 illustrates time-stamped mouse micromotions captured by a software component according to the present invention.

FIG. 16 illustrates an exemplary way of creating a master mouse micromotions database.

FIG. 17 illustrates exemplary software components according to the present invention.

### DETAILED DESCRIPTION OF THE PREFERRED EMBODIMENT

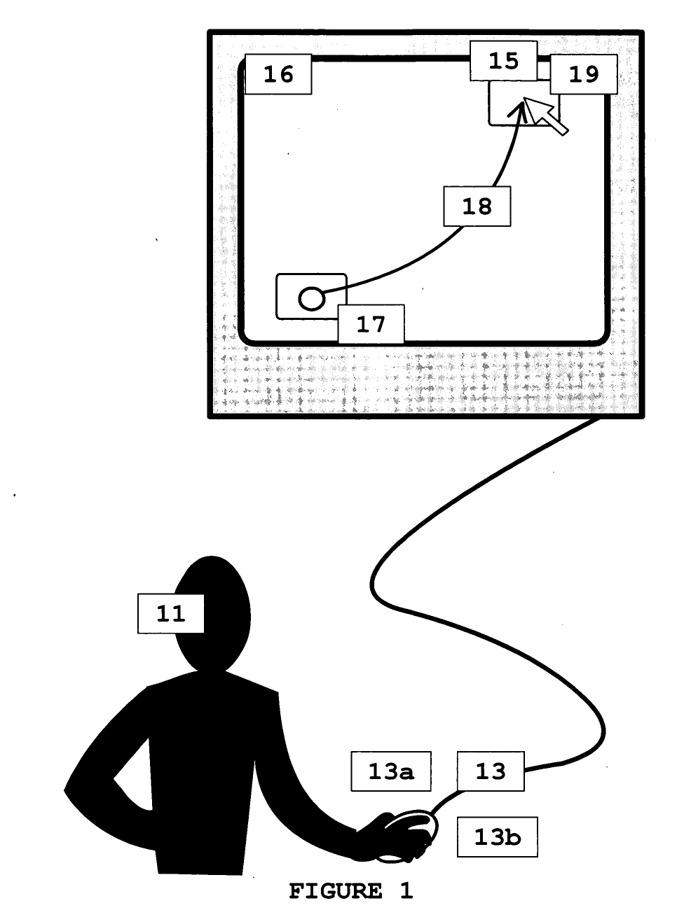

FIG. 1 illustrates some of the basic principles of the present invention. User 11 manipulates mouse 13 to move the cursor 15 from a first target area 17 on a computer screen 16 to a second target area 19. Typically, upon successfully moving or displacing (hereinafter “displacing”) the cursor 15 within the second target area 19, the user enters a mouse-click by clicking on the left button 13a of the mouse 13. In FIG. 1, the user 11 traces an arc 18 as he displaces the cursor 15 from the first target area 17 to the second target area 18. According to the principles of the present invention, the way the user 11 manipulates the mouse 13 depends on the anatomical features of his hand with which he manipulates the mouse 13, as well as his temperament and other psychological factors. Ordinary computer programs or GUI's only record the mouse-clicks entered at the first and second target areas. However, software components according to the present invention look to the trace 18 that user 11 makes as he manipulates the mouse 13 as well as other unconscious mouse movements the user causes as he enters a mouse-click. In particular, the term “mouse micromotion” refers to any movement, track or trace of the mouse 13 as the user manipulates the mouse to move it from one point on the computer screen 16 to another point on the screen. Defined this way, the term “mouse micromotions” (also referred to as “micromotions” for short) can be viewed as the unintended, unconscious motions of the mouse 13 that the user 11 makes while he attempts to displace the cursor 15, which moves in response to or correspondingly to the movement of the mouse. Each individual has characteristic way of manipulating a mouse and the present invention uses an individual's characteristic mouse micromotions to determine whether to allow or disallow a user's request to access a network or perform an on-line transaction.

Software components according to the present invention uses a plurality of mouse metrics, including, but not limited to, accuracy, bias, click duration, confirmation dependency, convexity, double-click rhythm, mouse-down travel/drag, over-click, overshoot and braking, speed and acceleration, and tremor, jerking or wobbling. These physical metrics can be transformed into a virtual n-dimensional model whose principle axes make conform to these physical metrics or may lie along composite axes such as eigenvectors which abstractly represent user motion space. It would be obvious to one skilled in the art that some of these metrics are dependent on the anatomical features of the user's hand, as well as the user's psychological state, whether temporary or more lasting.

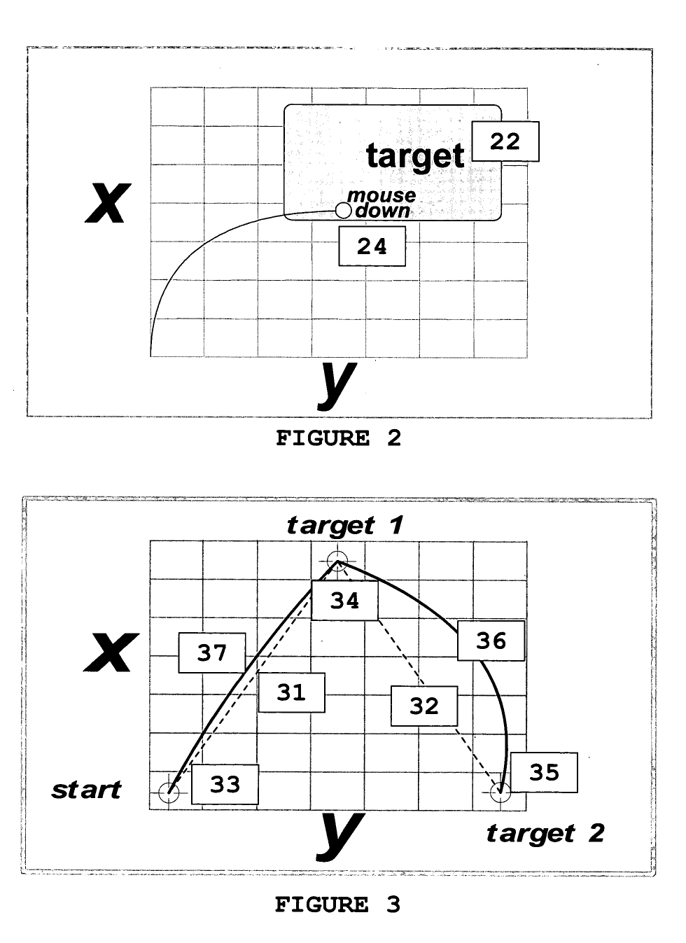

Accuracy: Different individuals have different degrees of accuracy in terms of the hand and eye coordination in moving or placing the cursor within a target area using the mouse (also referred to as “hitting a mouse target”). The accuracy metric captures where within the target area the cursor corresponding to the mouse is located when a mouse-click is entered. For example, the accuracy metric captures data relating whether the cursor corresponding to the mouse was near the border or center of the target area 22 when the mouse-click 24 is entered. (See FIG. 2).

Bias: Different individual have different motion bias. A person may manipulate the mouse outwardly when moving the mouse from a left comer to a right comer, while he may manipulate the mouse inwardly when moving the mouse in the opposite direction. Referring to FIG. 3, given the mirror imaged lines 31 and 32, the way an individual moves the mouse to displace the cursor (corresponding to the mouse) from point 33 to point 34 is characteristically different than when the individual moves the mouse to displace the cursor from point 34 to point 35. FIG. 3 illustrates an exemplary individual who has a relatively high degree of a motion bias; that is, he makes a drastically curved trace 36 when he attempts to displace the cursor from point 34 to point 35 while he makes a relatively flat curve 37 when he moves the mouse to displace the cursor from point 33 to point 34. The bias metric captures data relating to the motion bias of an individual user.

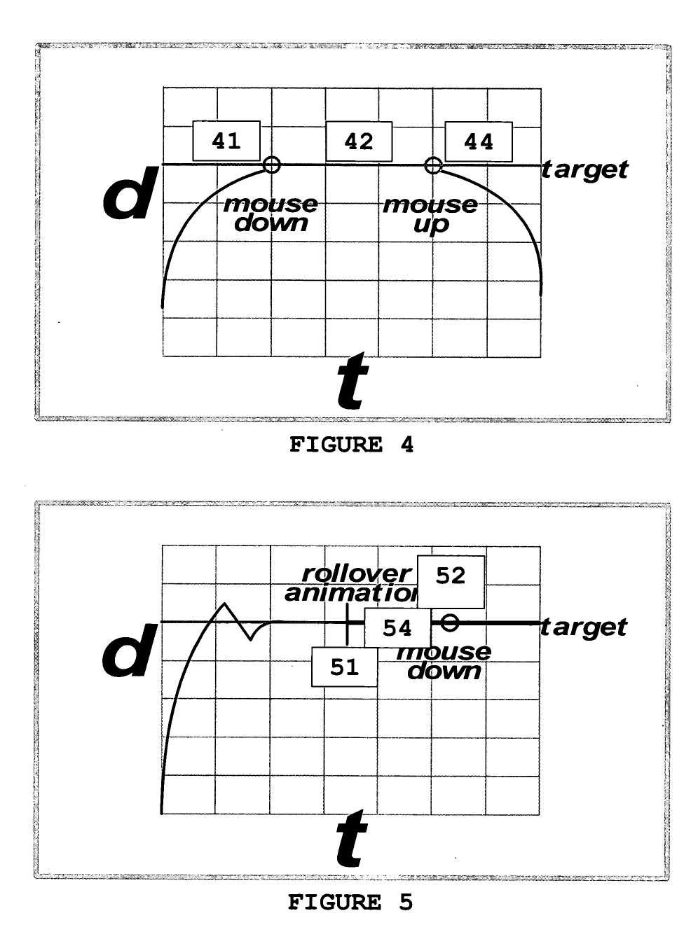

Click duration: In entering a mouse-click, which comprises the action of pressing (a mouse press event) and the action of releasing (a mouse release event) a mouse button, different individuals hold or press down the button for different durations of time. The click duration metric captures the time delay between the press and release of a mouse button of an individual user. In FIG. 4, reference number 41 represents the time at which a mouse button is pressed, while reference number 44 represents the time at which a mouse button is released. Thus, the distance represented by reference number 42 indicates the delay in time between the mouse press event and the mouse release event. The click duration metric captures data relating to the delay between a mouse press and a mouse release events.

Confirmation dependence: Different individuals have different degrees of desire, or need for a confirmation response. It is well known in the art to make the target area responsive to the user's mouse movement, e.g., making the target area brighter as the cursor corresponding to the mouse approaches or enters the target area. The confirmation dependence metric captures data relating to an individual user's dependence, reaction or response to a confirmation signal, such as a change in the target's brightness. This metric can be used to facilitate authentication of a user because a person may not click a mouse button until a confirmation signal is given to him, while another person may click the mouse button regardless of whether or not he receives a confirmation signal. In FIG. 5, reference number 51 represents the time at which a confirmation signal is given to an individual user, and reference number 52 represents the time at which the user presses a mouse button. The delay in time represented by reference number 54 is a function of an individual's characteristics and can be used to facilitate authentication of a user of a mouse.

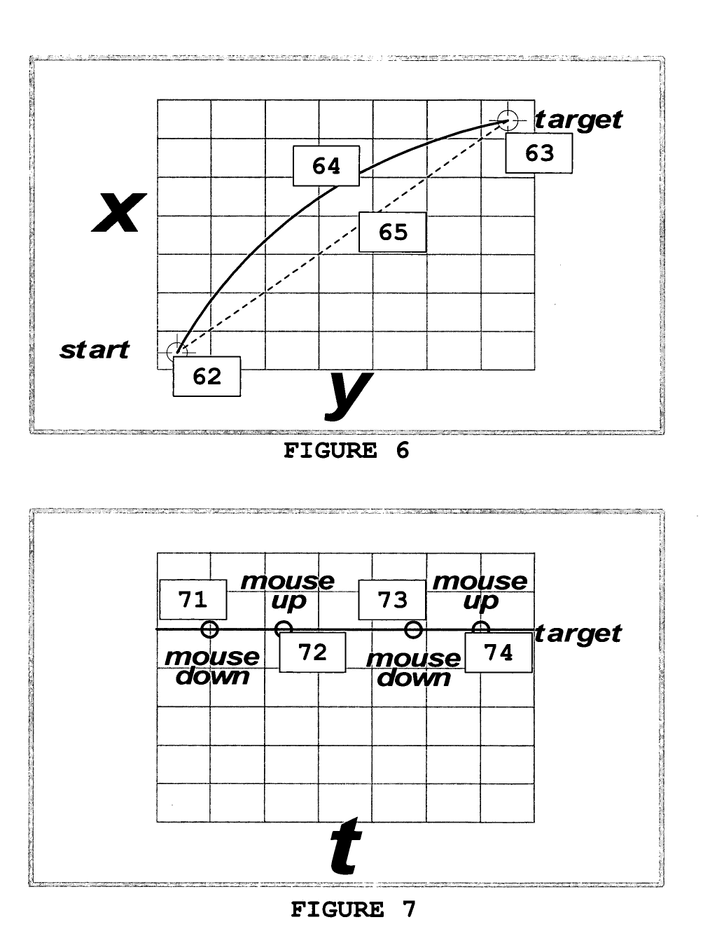

Convexity: Different individuals have different degrees of straying from the straight line connecting two points. In fact, while the shortest distance between two points is a straight line, it is rarely achieved; and in general, the actual path traced by the cursor corresponding to the mouse movement tends to bow either in or out. By applying analysis such as a low-pass filter to the mouse micromotion data, little tremors and jerks in the mouse movement can be removed and the degree of convexity or deviation from the straight path can be determined to facilitate authentication of the user of the mouse. In FIG. 6, as the user manipulates the mouse to move the cursor at point 62 to point 63, the user traces the path 64 instead of the straight line 65. Data relating to the deviation of the path 64 from the straight line 65 is captured by the convexity metric.

Double click rhythm: Certain computer programs or GUI's require a double click action from the user of a mouse. In “double clicking,” different individuals have different rhythms. The double click rhythm metric captures data relating to the time delays between in the sequence of press, release, press and release events and uses the time delays to facilitate authentication of the user of the mouse. In FIG. 7, reference numbers 71, 72, 73 and 74 represent the time at which a mouse button is pressed, released, pressed and released, respectively, as the user performs a double click operation. The double click rhythm captures data relating to the delay durations between the subsequent mouse events, which occur when a user performs a double click.

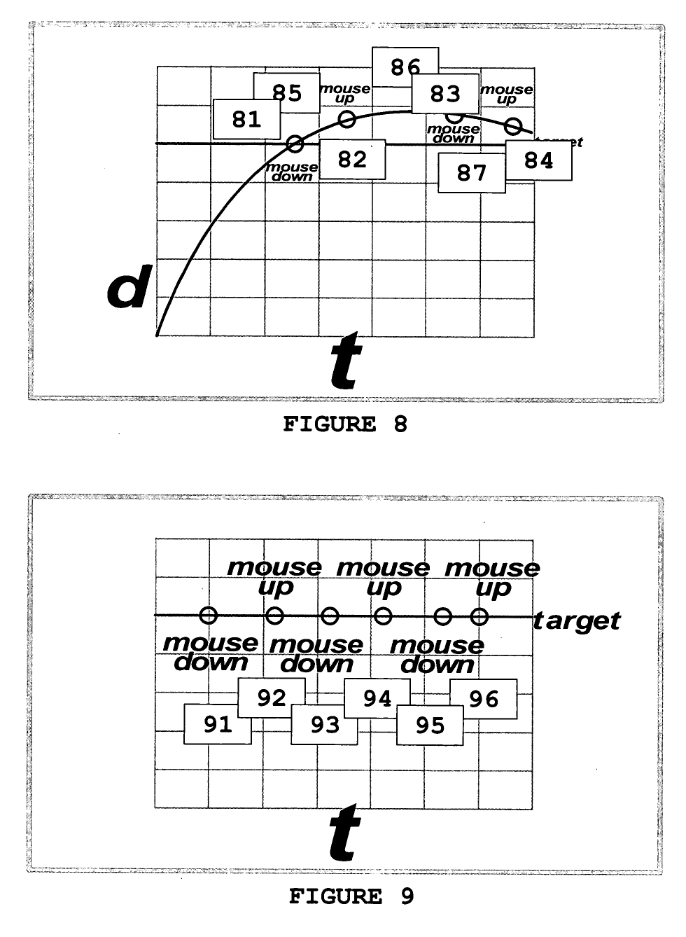

Mouse-down Travel and Inter-click Drag: Different users have different ways of handling the mouse and in some instances causing the mouse to move or slide a bit while acting to press down a mouse button. The mouse-down travel and inter-click drag metric captures data relating to the accidental movement or sliding of the mouse near or about the point at which the mouse-click is entered. In FIG. 8, reference numbers 81 and 82 represent the time at which a mouse button is pressed and released, respectively. Although, the mouse button should not move during these two events, the user accidental moves the mouse by the distance indicated by reference number 83. Similarly, during a double click operation, the mouse button should not move during the press, release, press and release events (for example, represented by 81, 82, 84 and 85); however, an individual user accidentally moves or slides the mouse button, for example, by the vertical distance of the arcs 83, 86 and 87.

Over-click: Different individuals have different incidents of over-clicking a mouse button. The over-click metric captures data relating to an individual's tendency to over-click a mouse button. In FIG. 9, reference numbers 91, 92, 93, 94, 95 and 95 represent mouse events within a target area 90, some of which represent events occurring due to the user's over-clicking tendency.

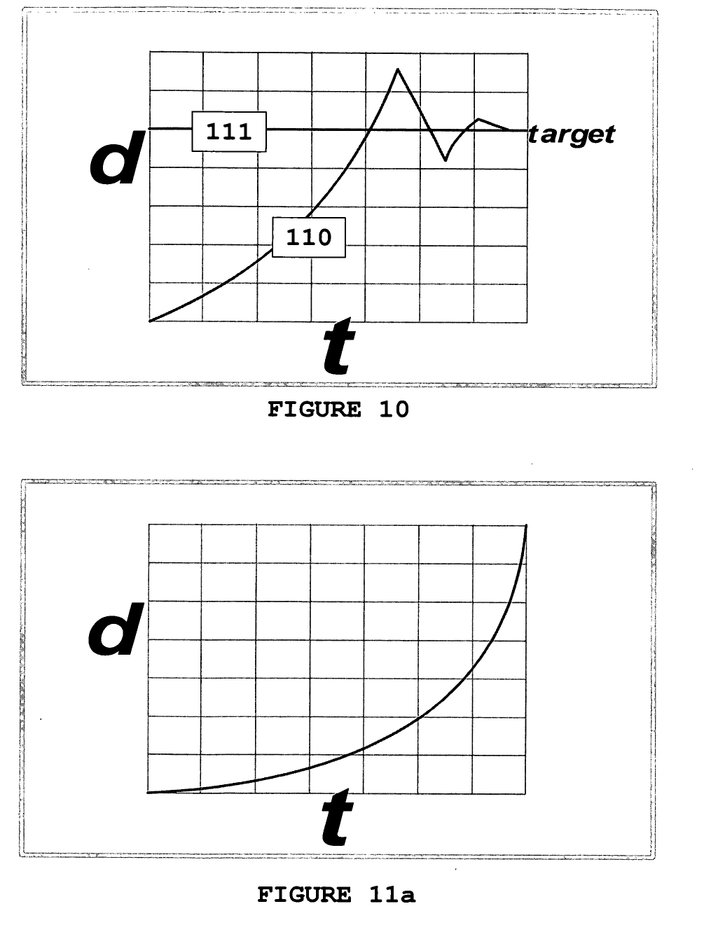

Overshoot and Braking: Different individuals have different ways of overshooting the target, or stopping or braking the motion of the mouse when the cursor corresponding to the mouse nears a target area. For example, some users move the mouse past a target and then pull the mouse back toward the target. Other users may stop or brake the movement of the mouse precisely within a target area. Still others drive or move the mouse cautiously braking the movement of the mouse before reaching the target area and then slowly pull the mouse toward the target. The overshoot and braking metric captures data relating to an individual's way of overshooting or braking the mouse movement as he attempts to move the cursor corresponding to the mouse to a target area. FIG. 10 illustrates the movement of a mouse (represented by 110) overshooting a target area, represented by reference number 111.

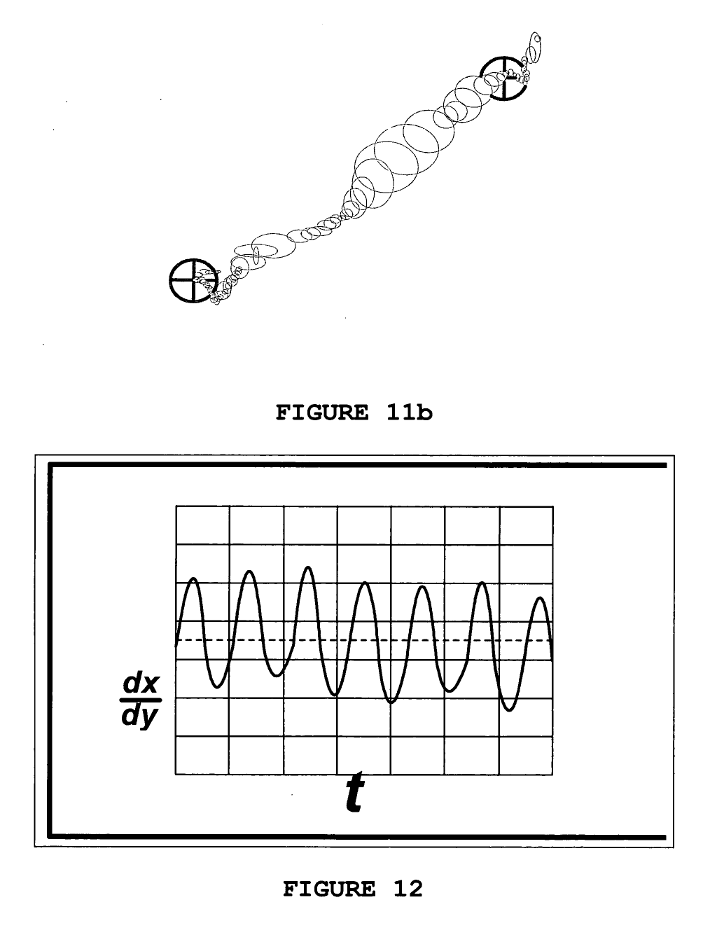

Power Curve: Different individuals move the mouse with different speeds and accelerations; that is, the maximum speed of the mouse-stroke is a variable, as is the acceleration from dead rest to the maxim stroke speed. This measure is equivalent to the drag racer's “zero to sixty metric.” The power curve metric captures data relating to an individual's way of speeding or accelerating a mouse as he manipulates the mouse. (See FIGS. 11a and 11b). In FIG. 11b, the radii of the circles or ellipses are proportional to the speeds of the mouse in the x and y directions at the points represented by the circles and ellipses.

Tremor and Wobble: Different individuals impart different degrees of tremor, jerking, or wobbling motions as they manipulate the mouse. The tremor and wobble metric captures data relating to an individual's tendency to impart tremor, jerking, and/or wobbling motions to the mouse as he manipulates the mouse. (See FIG. 12a).

Correction: Different individuals are seen to employ different path correction behavior. Referring to FIG. 12b, given a line 12b2 representing the shortest line or stroke between two points, some users over-correct and compensate repeatedly crossing the straight line 12b2 and tracing out a path represented by 12b2. Referring to FIG. 12c, other users approach the straight line path 12c from one side, always under-correcting and tracing out a path such as 12c2. Some users correct their strokes multiple times, while others make characteristically small numbers of corrections, such as one or two distinct corrections. FIG. 12d illustrates a path 12d2 traced out when a user make two distinct corrections at points 12d3 and 12d4 when the shortest path between two end points is represented by 12D.

In addition, certain psychological states of an individual can be extracted from the way the user manipulates the mouse. Using a psychological test developed and well known in the commercial survey field, certain psychological indicators (e.g., angry, depressed, timid, exuberant) of an individual user are determined based on the user's way of manipulating the mouse and used to facilitate authentication of the user.

An embodiment of the present invention may use all of the metrics discussed above to authenticate a user of a mouse. Another embodiment may use only a subset of the metrics. Any embodiment may use other metrics in combination with these or in place of them.

In addition, certain tricks may be used to enhance the determination, measurement, or capturing of desired metrics. For example, undersized hot-spots, off-center rollover, delayed confirmation, temporarily unclickable targets, and/or moving targets accentuate certain mouse micromotions, thereby making it easier to capture data relating to certain metrics. In addition, based on the mouse micromotion characteristics of an individual, certain tricks can be used to highlight the individual's repeatable micromotion characteristics.

In an exemplary database of the metrics comprising repeatable characteristic micromotions of individuals, each individual is tested for seven (7) times, each test comprising mouse-click entering ten (10) digits and a double-click.

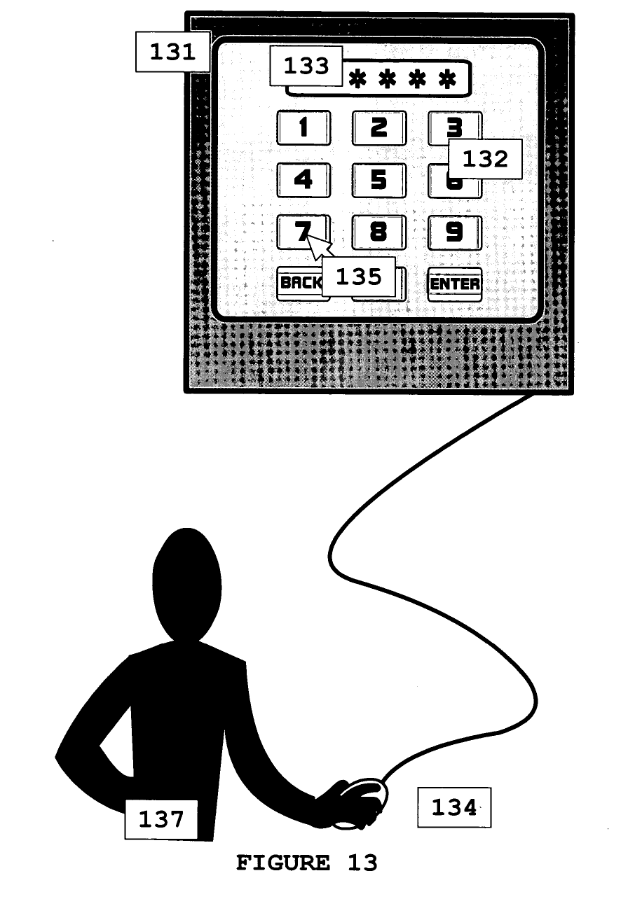

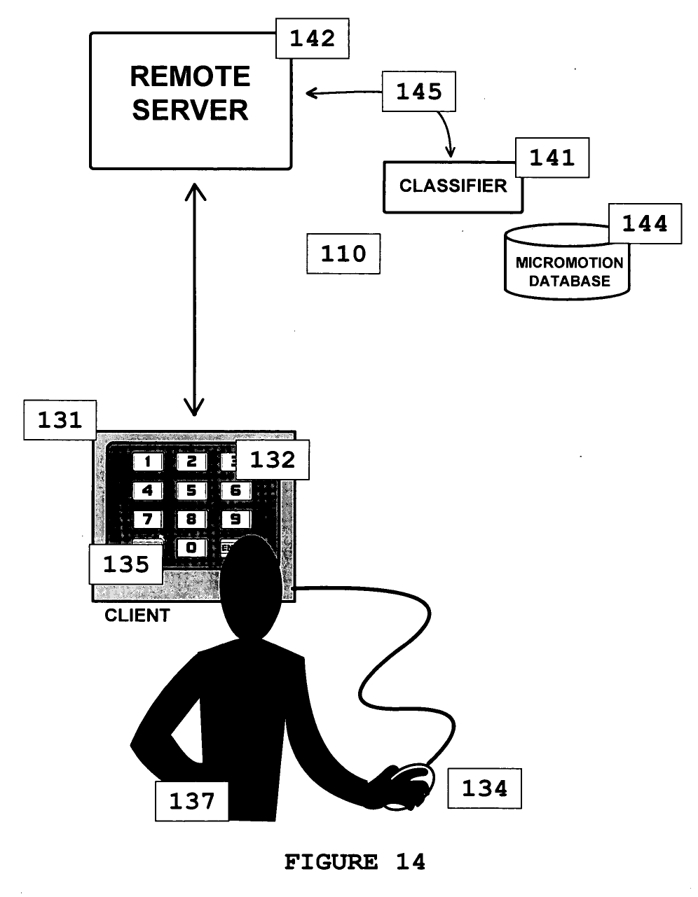

In a first embodiment according to the present invention, a user is directed to enter a sequence of alpha-numeric characters, e.g., a credit card number, using mouse-clicks. For example, referring to FIG. 13, a screen 131 showing a numeric character image 132 is presented to the user 137 of the present invention. As the user 137 enters a sequence 133 via the image 132 using the mouse 134, which controls or corresponds to the cursor 135, data relating to the micromotions of the mouse 134 is captured. The data relating to the micromotions of the mouse 134 is preferably locally stored and processed to yield feature vectors corresponding to the user 137. The term “feature vector” refers to a mathematical expression or representation of one or more of the metrics discussed previously, and determine or classify the characteristic micromotions of an individual. The feature vectors of the user 137 are then transmitted or communicated to a remote server 141 shown in FIG. 14, which server comprises a master mouse micromotion database 144. A comparison is made between the feature vectors transmitted to and received by the server 141 and the characteristic feature vectors associated with the authorized user of the sequence 133, which are available to the server 141 and are stored in the master database 144. Based on the result of the comparison, the remote serverl4l transmits a signal, for example a number 145, indicating a probability that the user 137 is indeed the authorized user of the sequence 133 to an on-line merchant or bank, 142.

In a preferred embodiment, a local micromotion sensor or detector (hereinafter “sensor”) gathers information relating to mouse micromotions of the user 137 as he manipulates the mouse, for example, to enter a credit card number, e.g., sequence 133. The sensor preferably works in conjunction with the browser program that the user 137 uses, and thus the sensor is embodied as a plug-in program or a JavaScript function or Java applet embedded in a web page accessed by the user's browser program. A sensor application can also be used independently from the user's browser program as well known to those skilled in the art. In addition, the server and the client model shown in FIG. 14 is for exemplary purposes only; software or hardware components according to the present invention can be used in a variety of computers, networks and architecture.

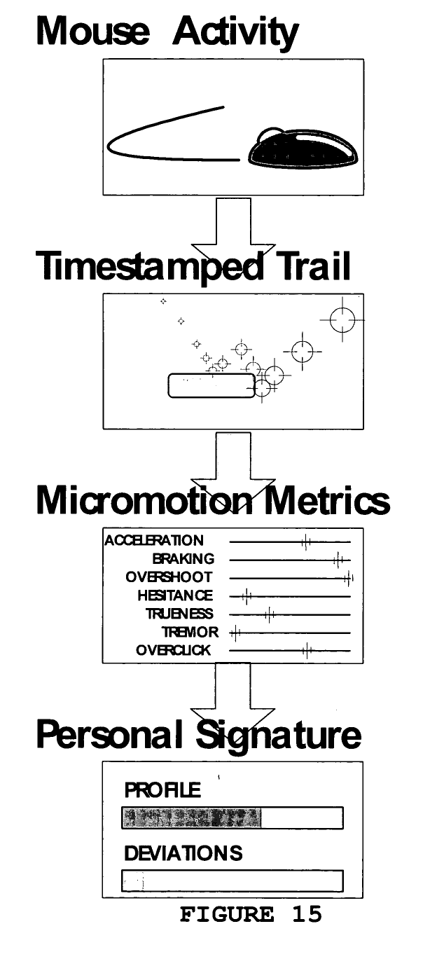

The micromotion sensor according to the present invention preferably associates a series of time-stamps with the micromotion data captured by the sensor as the user manipulates his mouse. (See FIG. 15). This data stream is then stored and processed by software components according to the present invention. In a preferred web-environment, the data is buffered or stored at the desktop or the client server and transmitted to a remote server either in a streaming or block mode.

Another preferred embodiment would permit the client software to reduce the data stream to feature vectors and transmit only these vectors in order to conserve the bandwidth and better distribute the processing load.

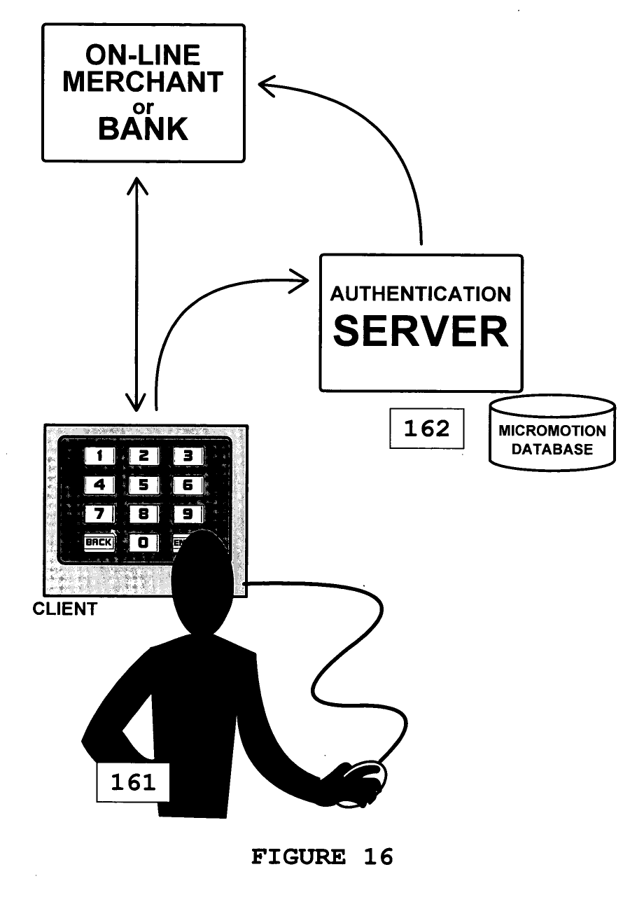

The master mouse micromotions database 144 is built, for example, when an owner of a credit card signs up to be an authorized user. Referring to FIG. 16, in the credit card context, the owner 161 performs certain mouse manipulations when he signs up for a credit card. Similarly, in the network access context, i.e., an authorized user performs certain mouse manipulations when he is initially given the authorization permitting him to have access to a particular network. As the user manipulates the mouse to perform the task requested at the initial sign up time, the user's characteristic feature vectors are determined and are stored in the master mouse micromotions database 162. For example, a classifier or micromotion catalog program places and stores the micromotions associated with each authorized individual for later retrieval and comparison. This process is often referred to as “training” the classifier.

In particular, a software component, micromotion catalog, tracks and captures data relating to the metrics discussed above and extract a set or stream of mouse micromotions (hereinafter “micromotion event stream”), which may include all or subset of the metrics discussed above, including but not limited to data reflecting such as hesitancy, tremor, convexity, and mouse drag. A library of mathematical methods is then applied to the mouse micromotion event stream to extract the metrics and develop feature vectors characteristic of an individual user. The mathematical methods include, among other things, Fourier analysis, KLT, statistics, matrix transformations, kinematics, and other processing techniques. As an example, path convexity may require application of a low-pass filter. According to the principles of the present invention, the micromotion catalog comprises feature vectors corresponding to metrics that are both repeatable and characteristic of an individual.

Typically, mouse micromotions according to the present invention are an order of magnitude smaller than the typical mouse clicks that are of interest to conventional hardware and software devices. For mouse motions in the order of seconds, the micromotions are in the 10^{th} or 100^{th} of the seconds. In addition, the metrics characterizing the way an individual user handles, moves or manipulates a mouse are standardized or abstracted out from the particular software and hard interface components used by the user. The standardization or abstraction process allows the mouse micromotions characteristic of an individual to be determined independent of such interface components. The standardization process preferably operates during run time.

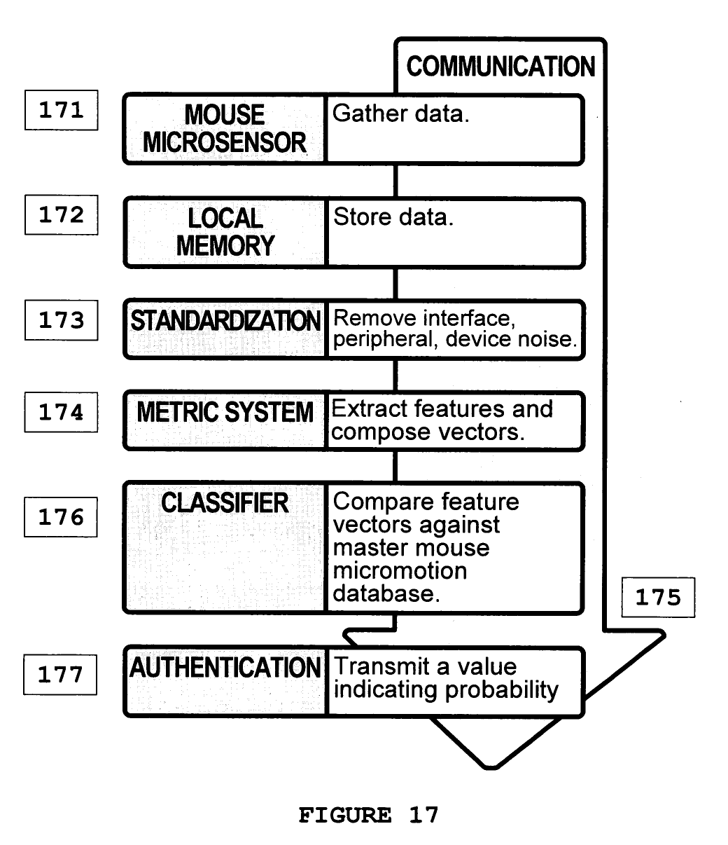

FIG. 17 illustrates exemplary software components according to the present invention. A microsensor 171 captures or gathers data relating the movement of a mouse. A local memory 172 stores the raw data and a standardization process 173 removes noise or data dependent on the particular hardware and software devices used by the user of the mouse. A metric system. 174 extracts data representing the metrics discussed above and determine feature vectors of the user of the mouse. Software components 171, 172, 173 and 174 are accessible by the client server. Once feature vectors for the user of the mouse are determines, the vectors are transmitted to a remote server side. A conventional communication component 175 is used to communicate the feature vectors. On the server side, a classifier 176 classifies or maps the feature vectors and performs a comparison of the received feature vectors against the data in a master micromotion database. After the comparison, an authentication component 177 determines a value indicating the likelihood or probability of the user being an authorized person.

Accordingly, the present invention can be used to facilitate authentication of a customer making an on-line purchase or any on-line transaction. For example, when making an on-line purchase, a cardholder uses a mouse device to enter his credit card number by clicking a sequence of authorization mouse-clicks via an on-screen keypad image. The micromotion pattern of the user is captured and then matched against a stored profile of the authorized user associated with the credit card number, and the identity of the cardholder is verified. Another embodiment according to the present invention is authentication of the person to whom sensitive information such as medical information can be released. Another embodiment according to the present invention is authentication of the voters in an Internet voting system. Furthermore, an embodiment according to present invention can be used to facilitate network security and network access.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive use of all modifications which come within the scope of the appended claims is reserved.

1. A method of human authentication in a system comprising a computer and a mouse, said method comprising
a: detecting mouse movements of a user;
b: obtaining at least one metric of mouse movement information characterizing the user;
c: comparing the metric against a database; and
d: authenticating the user.

2. A method according to claim 1 wherein the method provides information regarding the user's class identity.

3. A method according claim 1 wherein the step of detecting the mouse movements of the user is executed without the user's awareness.

4. A method according to claim 1 wherein the database comprises an aggregated representation of previously detected mouse movement information.

5. A method according to claim 1 wherein the comparison between the metrics and the database uses at least one eigenvector derived from the metrics.

6. A method according to claim 1 wherein the user's mouse movements are in response to a display on the computer's screen.

7. An information processing system for identifying its users, the system comprising:
an arrangement of sensors for detecting a user's mouse movements;
a memory unit for storing the detected user's mouse movements;
a computational element for obtaining at least one metric from the user's mouse movements and manipulating the metric; and
a database.

8. A system according to claim 7 wherein a target pattern is used to elicit information known only to an authorized user.

9. A system according to claim 8 wherein a target pattern that changes from a session to session is used to elicit the user's mouse movements.

10. A system according to claim 7 wherein said information processing system is distributed over a plurality of networked devices.

11. A system according to claim 7 is used for online commercial transactions.

12. A system according to claim 7 is used for online voting.

13. A system according to claim 7 is used for network access.

14. A system according to claim 7 is used to authorize the release of sensitive personal records.

15. A system according to claim 7 wherein said information processing system is a single computer.
